(19) United States
(12) Patent Application Publication
(10) Pub. No.: US 2007/0235380 A1
(43) Pub. Date: Oct. 11, 2007

(54) Pool skimmer device for surface debris

(76) Inventor: Scott Cawein, Milpitas, CA (US)

Correspondence Address: Dergosits & Noah LLP, Suite 1450, Four Embarcadero Center, San Francisco, CA, 94111, US

(21) Appl. No.: 11/401,725

(22) Filed: Apr. 10, 2006

(51) Int. Cl. C02F 1/40

(52) U.S. Cl. 210/242.1

(57) ABSTRACT

A skimmer device for collecting and retaining debris from a surface of a body of water. The skimmer device includes a buoyant body for floating on the water surface having a front and rear portions. A debris collecting channel passes between the front and rear portions, the skimmer device also including a propulsion system for moving the buoyant body through the body of water in the direction of the front portion. The propulsion system includes a plurality of electric motors, each of which is in functional engagement with the proximal end of a shaft, a propeller being positioned at the distal end of each shaft. The motors are capable of turning at the same or different speeds to enable the skimmer device to travel on a surface of a body of water in a predetermined direction. A debris bag is appended to the rear portion of the buoyant body at the debris collecting channel to capture debris entering the debris collecting channel at the front end of the buoyant body.

### TECHNICAL FIELD

The present invention is directed to a skimmer device designed to travel on the surface of a body of water, such as a swimming pool and to travel thereon collecting and retaining debris. When appropriately sized and ruggedized, this device can also be employed in harsher more commercial environments such as on lakes, oceans, rivers and streams where debris collection is a priority.

### BACKGROUND OF THE INVENTION

There have been a plethora of devices suggested in the prior art capable of cleaning debris from a body of water, such as a swimming pool. Most such devices travel along the bottom and sidewalls of the pool and are connected to hosing for capturing and removing such debris as it settles to the pool floor. Unfortunately, such devices suffer from a number of limitations.

Submerged cleaning devices such as those described above, can often times over turn as they confront sloping sidewalls of the pool. Once over turned, they generally do not continue their cleaning function unless an operator intervenes. Further, floating debris, such as animal fur tends to remain upon the surface of the body of water which would be inaccessible to a submergible cleaning device. The surface retained debris is particularly problematic for it tends to be drawn within circulating pumps, fouling such hardware and resulting in increased down time and maintenance costs.

There have been other devices which have been suggested for cleaning debris from the surface of a body of water. One of such devices is described in U.S. Pat. No. 6,074,553, the disclosure of which is incorporated herein by reference. The device described in the '553 patent does act as a water skimmer but suffers from a number of disadvantages addressed herein.

Specifically, the '553 patent teaches a skimmer which employs a single electric motor for propelling the skimmer on the surface of the body of water to collect debris. In that only a single motor is provided, the '553 device must rely upon rather elaborate rudder controls to enable the device to change direction particularly if it confronts the side walls of the pool or a floating object, such as a floating lounge chair or pool toy during its cleaning cycle. Controlling the direction of travel and changing it at will is obviously of high importance in evaluating skimmer devices such as those described in the '553 patent for it is important that the device covers and thus cleans the highest possible surface area of the body of water.

It is thus an object of the present invention to provide a skimmer device capable of cleaning the surface of a body of water without experiencing the limitations of the prior art.

This and further objects will be more readily appreciated when considering the following disclosure and appended claims.

### SUMMARY OF THE INVENTION

A skimmer device for collecting and retaining debris from the surface of a body of water. The skimmer device comprises a buoyant body for floating on the surface, a front portion and a rear portion and a debris collecting channel passing between the front and rear portions of the buoyant body. The invention further embraces a propulsion system for moving the buoyant body through the body of the water substantially in the direction of the front portion. The propulsion systems comprises a plurality of electric motors, each motor being in functional engagement with a proximal end of a shaft with a propeller positioned at the distal end of each shaft, the shafts being capable of turning at the same or different speeds to enable the skimmer device to travel on the surface of the body of water in a predetermined direction. The device further includes a debris bag appended to the rear portion of the buoyant body at the debris collecting channel to capture debris entering the debris collecting channel at the front end thereof.

### BRIEF DESCRIPTION OF THE FIGURES

FIG. 1 is a top plan view of the skimmer device of the present invention with its cover removed to show its internal components.

FIG. 2 is a rear plan view of the skimmer device of the present invention.

FIG. 3 is a side plan view of the skimmer device of the present invention.

FIG. 4 is a top plan view of the skimmer device of FIG. 1 with its cover in place.

### DETAILED DESCRIPTION OF THE INVENTION

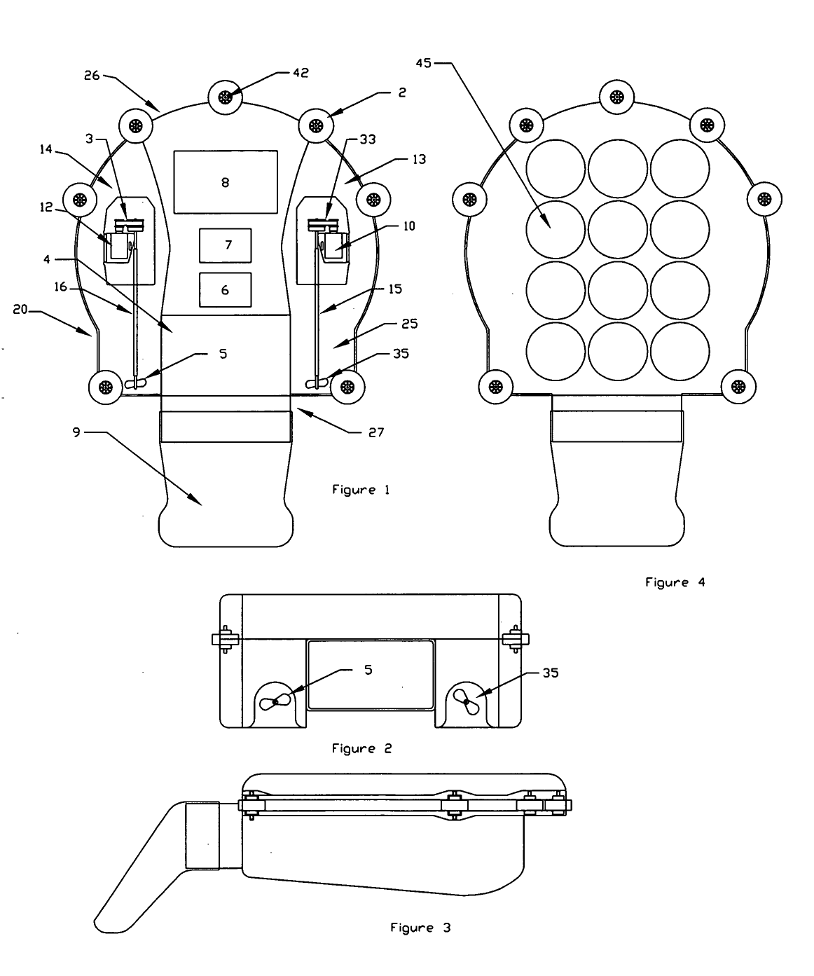

Turning first to FIG. 1, skimmer device 20 is depicted. Skimmer device 20 is shown having buoyant body 25 for floating on a surface of water. Buoyant body 25 is characterized as having a front portion 26 and a rear portion 27 and a debris collecting channel 1, ideally in the form of a venturi to enhance the flow of debris through channel 1 from front portion 26 to rear portion 27.

A debris collecting bag, such as nylon bag 9 is appended to rear portion 27 at the end of channel 1 such that as skimmer device 20 travels on a body of water, debris entering venturi 1 at front portion 26 will be collected in bag 9 which is removable upon emptying. A significant improvement in the device of the present invention over the prior art, and particularly that disclosed in U.S. Pat. No. 6,074,553 is in the propulsion system employed for moving skimmer device 20 substantially in the direction of front portion 26. Specifically, the propulsion system of the present invention comprises a plurality of electric motors, in the embodiment shown in FIG. 1, two DC motors 10 and 12 are shown in embedded within buoyant body 25 in compartments 13 and 14, respectively, to isolate these motors from their aqueous environment. Each such motor is connected to the proximal end of shafts 15 and 16 noting that each of said shafts has a distal end supporting propellers 35 and 5.

It is important in constructing a skimmer device such as that disclosed herein to enable it to travel on the surface of a body of water at a predetermined fixed direction or variable direction to enhance the opportunity for the skimmer device to cover as much of the water surface as possible and thus to maximize debris collection. Also, if this device is constructed to move in an arc or non linear direction, when an obstacle or corner is confronted, the device will maximize its opportunity to free itself.

In the first embodiment, motors 10 and 12 can be made programmable to operate at different speeds to create an arc of travel of buoyant body 25 on the body of water. Electronic circuit 6 can be provided for this purpose. Not only can electronic circuit 6 establish constant differential motor speeds, but it is contemplated that electronic circuit 6 be adjustable to adjust motor speeds of each of motors 10 and 12, independently, to adjust directionality of buoyant body 25.

In conjunction with electronic circuit 6, electronic timing circuit 7 can be included within the present device. The timer can be set to perform a number of functions. For example, timing circuit 7 can act, in conjunction with electronic circuit 6, to alternate the direction of the skimming device periodically, for example, every 10 seconds. This creates a randomness of movement to again maximize coverage of the water body surface.

Another way of creating a desired arc of travel is to provide pulley, belt combinations 33 and 3 which connect the output for motors 10 and 12, respectively to shafts 15 and 16 respectively. If pulleys 33 and 3 are made of different diameters, DC motors 10 and 12 operating at the same speed would produce shaft rotational speeds that differ. This would, in turn, create a differential for propeller speed and thus move the skimmer device of the present invention in a non linear fashion.

The present propulsion system represents a significant improvement over those suggested by the prior art and, specifically, that disclosed in the '553 patent. The prior art, in using a single motor, is required to employ a rudder system which adds mechanical complexity to the patented skimmer device. In the configuration shown by the prior art, a plurality of probes situated within guide rails are employed which, upon striking an obstacle, such as a side wall of a pool, changes rudder direction through a rather complex mechanical linkage. Such devices tend to be unreliable particularly where it is intended for such water skimmers to engage surface debris. In that the electronic circuitry, motors and shafts of the present invention are embedded within buoyant body 25, no such issues appear herein.

It is contemplated that as skimmer device 20 moves in the general direction of front portion 26, the side walls of the pool and other obstacles such as floating lounge chairs and toys will be confronted. In anticipation of this, buoyant body 25 employs a series of protective bumpers on its periphery. As a preferred embodiment, these bumpers are in the form of rubber wheels 2 rotatably supported on axles 42 arranged about the periphery of buoyant body 25 perpendicular to the plane of the body of water upon which skimmer device 20 is intended to travel. In employing rotatable rubber wheels, as buoyant body 25 strikes, for example, the side wall of the pool, the device is merely deflected in a direction away from the obstacle without damaging either skimmer device 20 or the confronted surface or object.

It is further intended that skimmer device 20 of the present invention be self powered. There are a number of ways of accomplishing this such as the use of sealed lead acid battery 8. Alternatively, the present invention can employ a bank of solar cells such as those depicted in FIG. 2 of the '553 patent, the disclosure of which is incorporated by reference herein.

In summary, the present invention involves a skimming device capable of removing debris from approximately the top 2 inches of water that it moves through. The propulsion system is in the form of, ideally, dual DC motors connected through belts and pulleys to shafts and propellers. Each propulsion unit is located on either side of buoyant body 25. Directional control is achieved by means of pulley ratios that form a random arc while moving through the water. Additionally, a timing circuit is supplied to change the direction of the skimming device periodically, for example, every ten seconds. The randomness of movement, allows full coverage of any contained body of water. As the device moves through the water, the water is channeled through the opening of the venturi channel at front portion 26. A common nylon bag or other collection expedient is affixed to the rear portion 27 of venturi channel 1 as the device moves through the water and directs the water and debris into the collection bag. The bumpers, such as soft rubber wheels 2 are appropriately located on the perimeter of buoyant body 25 to allow it to “bump” into an obstacle and be deflected to allow continuous cleaning. If wheels are employed, they should be located such that only the wheels will contact an obstacle and afford the deflection described herein.

As noted previously, the present invention can employ a timing circuit that can be set for significant on/off times to allow unattended daily cleaning. Further, if a swimming pool is made the subject of the present device, it can, for example, be cleaned in one hour and the unit allowed to rest and recharge by solar cells 45 (FIG. 4) to repeat its cleaning cycle. Ideally, on board batteries 8 supply power to the device where solar cells are employed to charge the battery.

It is understood that while certain forms of the present invention have been illustrated and described, it is not to be limited to the specific forms or arrangements or parts described as shown.

1. A skimmer device for collecting and retaining debris from a surface of a body of water, said skimmer device comprising a buoyant body for floating on said surface, a front portion and a rear portion and a debris collecting channel passing between said front and rear portions, a propulsion system for moving said buoyant body through said body of water substantially in the direction of said front portion, said propulsion system comprising a plurality of electric motors, each motor being in functional engagement with a proximal end of a shaft and a propeller positioned at a distal end of said shaft, said shaft being capable of turning at the same or different speeds to enable said skimmer device to travel on said surface of said body of water in a predetermined direction and a debris bag appended to said rear portion of said buoyant body at said debris collecting channel to capture debris entering said debris collecting channel at said front end thereof.

2. The skimmer device of claim 1 wherein said motors are programmable to operate at different speeds to create an arc of travel of said buoyant body on said body of water.

3. The skimmer device of claim 1 further comprising a control circuit for adjustably controlling the motor speed of each of said plurality of motors to adjustably control the direction of travel of said buoyant body on said body of water.

4. The skimmer device of claim 1 wherein each of said plurality of motors is connected to a pulley positioned on each of said shafts wherein said shafts rotate in response to a belt traveling over said motors and pulleys.

5. The skimmer device of claim 4 wherein said each of said pulleys are of different sizes so that each of said shafts turn at different rates to predetermine the arc of travel of said buoyant body in said body of water.

6. The skimmer device of claim 1 wherein protective bumpers are positioned on the periphery of said buoyant body to protect said buoyant body from damage.

7. The skimmer device of claim 6 wherein said protective bumpers comprise a plurality of compressible wheels.

8. The skimmer device of claim 6 wherein each of said wheels is rotatable about a wheel shaft as said buoyant body contacts an object external to said periphery.

9. The skimmer device of claim 1 further comprising a timing circuit for controlling the period in which said buoyant body travels through said body of water.

10. The skimmer device of claim 1 wherein a power supply for said plurality of motors is housed within said buoyant body.

11. The skimmer device of claim 10 wherein said power supply comprises a battery source.

12. The skimmer device of claim 10 wherein said battery source is charged with a solar cells source.
